(19) United States
(12) Patent Application Publication
(10) Pub. No.: US 2024/0290308 A1
(43) Pub. Date: Aug. 29, 2024

(54) Granular User Feedback Tracking for Generative Music Systems

(71) Applicant: Aimi Inc., Littleton, CO (US)

(72) Inventors: Edward Balassanian, Austin, TX (US); Patrick E. Hutchings, Melbourne (AU)

(21) Appl. No.: 18/585,754

(22) Filed: Feb. 23, 2024

Related U.S. Application Data
(60) Provisional application No. 63/490,843, filed on Mar. 17, 2023.
(60) Provisional application No. 63/486,902, filed on Feb. 24, 2023.

(51) Int. Cl. G10H 1/00; G06N 3/08

(52) U.S. Cl. CPC G10H 1/0025; G06N 3/08; G10H 2210/036; G10H 2210/111

(57) ABSTRACT

Techniques are disclosed that pertain to generating output music content based on musical embeddings. A computer system generates output music content that includes multiple overlapping musical expressions in time. The computer system receives user feedback at a point in time while the output music content is being played. Based on the user feedback and based on characteristics of the output music content associated with the point in time, the computer system determines one or more expression embeddings generated based on expressions selected for inclusion in the output music content and one or more composition embeddings generated based on combined expressions in the output music content. The computer system generates additional output music content based on the expression and composition embeddings.

### CROSS REFERENCE TO RELATED APPLICATIONS

The present application claims priority to U.S. Provisional App. No. 63/490,843, entitled “Aimi and sonic DNA,” filed Mar. 17, 2023. The present application also claims priority to U.S. Provisional App. No. 63/486,902, entitled “Training Machine Learning Model based on Music and Decisions Generated by Expert System,” filed Feb. 24, 2023.

This application is related to the following U.S. application Ser. No. ______ filed on ______ (Attorney Docket Number 2888-02001).

Each of the above-referenced applications is hereby incorporated by reference as if entirely set forth herein.

### BACKGROUND

### Technical Field

This disclosure relates to audio engineering and more particularly to generating music content.

### Description of Related Art

Streaming music services typically provide songs to users via the Internet. Users may subscribe to these services and stream music through a web browser or application. Examples of such services include PANDORA, SPOTIFY, GROOVESHARK, etc. Often, a user can select a genre of music or specific artists to stream. Users can typically rate songs (e.g., using a star rating or a like/dislike system), and some music services may tailor which songs are streamed to a user based on previous ratings. The cost of running a streaming service (which may include paying royalties for each streamed song) is typically covered by user subscription costs and/or advertisements played between songs.

Song selection may be limited by licensing agreements and the number of songs written for a particular genre. Users may become tired of hearing the same songs in a particular genre. Further, these services may not tune music to users' tastes, environment, behavior, etc.

### BRIEF DESCRIPTION OF DRAWINGS

FIG. 1 is a block diagram illustrating a system configured to train a machine learning model (e.g., a neural network) to generate music based on information from a rules-based expert system, according to some embodiments.

FIG. 2 is a detailed block diagram illustrating a system configured to train a machine learning model using an expert system, according to some embodiments.

FIG. 3 is a block diagram illustrating an example system configured to generate synthetic user feedback, according to some embodiments.

FIG. 4 is a diagram illustrating example expert system recording and spectrogram upscaling, according to some embodiments.

FIG. 5A is a block diagram illustrating an example user profile with embeddings based on user feedback, according to some embodiments.

FIG. 5B is a block diagram illustrating example aggregation of user profile embeddings with greater emphasis on more recent feedback, according to some embodiments.

FIG. 5C is a diagram illustrating example data structures for storing loop and mix emphasis information, according to some embodiments.

FIGS. 6A-6C show example vectors in a simplified two-dimensional composition space, according to some embodiments.

FIG. 7 is a block diagram illustrating example aggregation and sharing of user profile information, according to some embodiments.

FIG. 8 is a block diagram illustrating example training of a contrastive model, according to some embodiments.

FIG. 9 is a diagram illustrating example feedback embeddings stored in a user profile, according to some embodiments.

FIG. 10 is a block diagram illustrating an example loop filter model, according to some embodiments.

FIGS. 11 and 12 are flow diagrams illustrating example methods, according to some embodiments.

### DETAILED DESCRIPTION

### Introduction to Training a Machine Learning Model Using an Expert System

The AiMi music generator is an example application configured to generate custom generative music content. Some embodiments of the system utilize an expert system that executes AiMi script to interface with the AiMi Music Operating System (AMOS). The system may select and mix audio loops based on user input (e.g., regarding a desired category of music) and feedback (e.g., a thumbs up or thumbs down rating system, time spent listening to certain compositions, etc.).

Therefore, an expert system (e.g., the current AiMi system) may exist that has been trained to generate music that sounds like human-composed music. The expert system may be rules-based and utilize a probability-based model to select loops, combine loops, and apply effects. The expert system may output a performance script to a performance system that actually combines the loops and applies the affects to generate mixed raw music data.

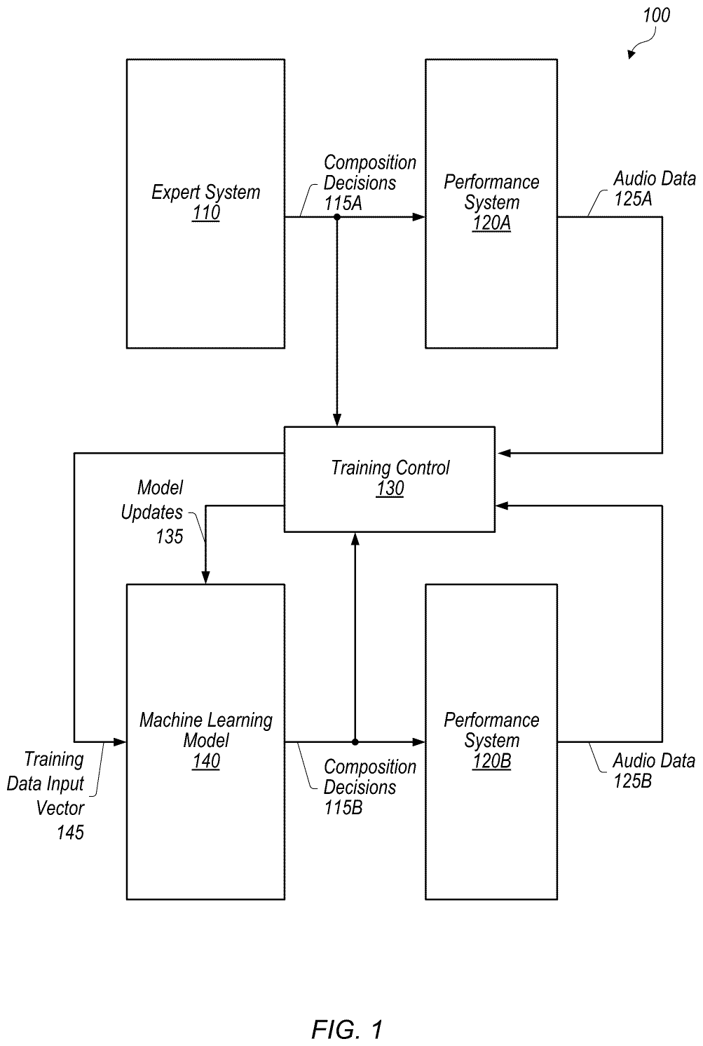

In disclosed embodiments discussed in detail below (e.g., in FIGS. 1-4), both music generated by the expert system and decisions made by the expert system (e.g., loop selection, effects, etc.) are used to train a machine learning model (e.g., implemented using a neural network) to generate similar music. In some embodiments, the machine learning model is trained without using any human-composed music as training data.

This may have several advantages, at least in some embodiments. First, in certain scenarios, it may be desirable to generate music with a certain style without using loops or mixing rules from previous human compositions. For example, music generated by the machine learning model that was trained by the expert system may reduce or avoid copyright infringement concerns. (Note that while certain implementations or applications may avoid copyright concerns, various disclosed techniques may also be used with input from human composers, using specific artist's loops, etc., in which case royalties for copyright may be appropriate, and the generative system may track such use for proper compensation).

As a second advantage, the trained machine learning system may be able to operate on highly-complex input vectors that might be impractical for processing by the expert system. For example, the model may utilize spectrogram data corresponding to recent output for use in generating subsequent output, etc. Further, use of decisions from the expert system during training may improve accuracy and speed of training, relative to training only on raw audio data, for example.

As a third advantage, the machine learning system may be further refined, e.g., based on user feedback, to internally implement music composition techniques that would be difficult or impossible to implement in a rule-based expert system (e.g., intuitive techniques that humans may struggle to define as rules; where humans may not even be aware what technique leads to “desirable” music). Said another way, the machine learning model may produce using musical intuition even if developers do not know how to write corresponding composition rules.

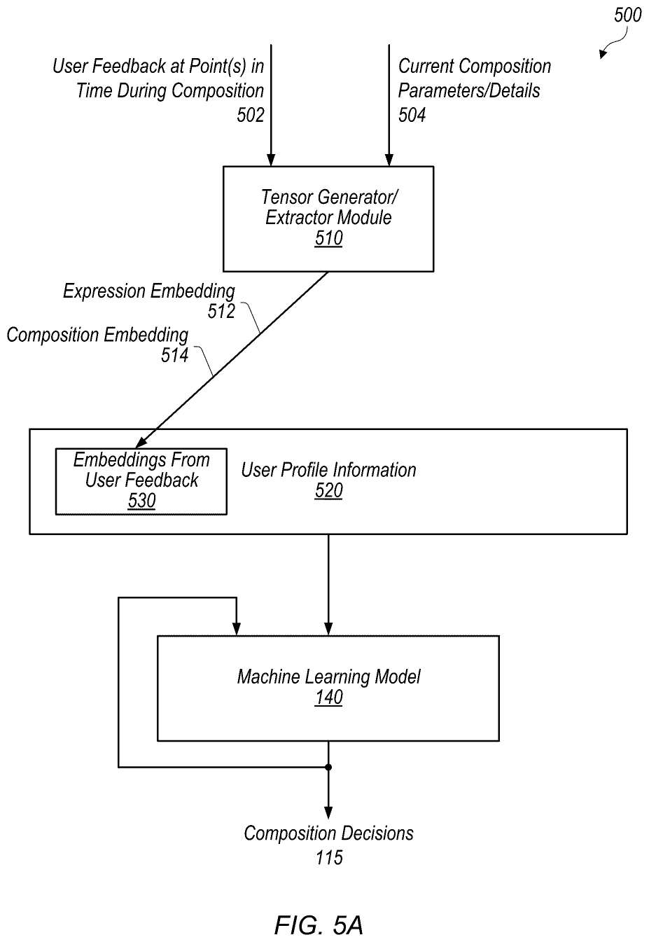

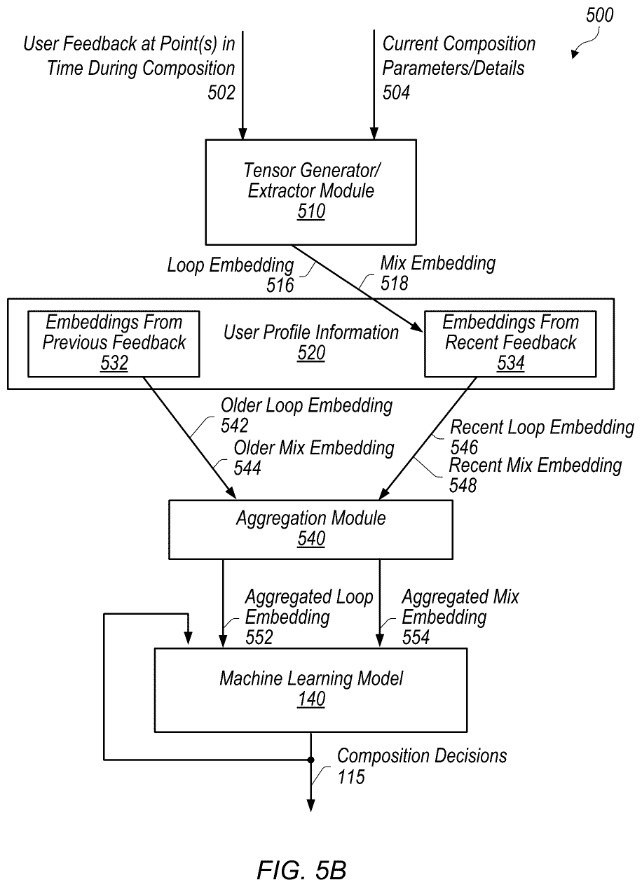

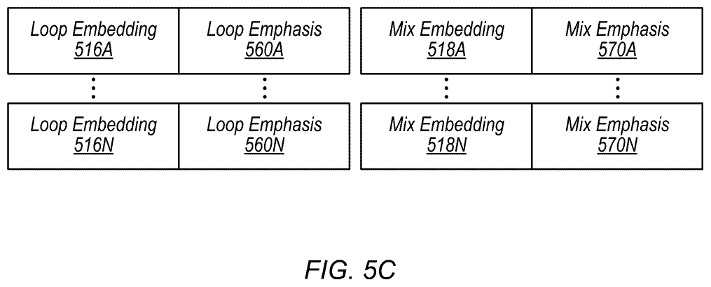

As a fourth advantage, the machine learning model may be further refined to provide music for specific users or groups of users (e.g., corresponding to a user profile) with flexibility that would be difficult in an expert system. For example, the description of FIG. 5A and the following figures provide examples of detailed user profiles that may be input to the model.

U.S. patent application Ser. No. 17/408,076 filed Aug. 20, 2021 and titled “Comparison Training for Music Generator” discusses techniques relating to reinforcement learning for generative systems. The present disclosure adds or extends to the techniques of the '076 application in at least the following ways. First, disclosed embodiments utilize actions/decisions by an expert system (e.g., loop selection, mixing commands, etc.) as well as audio output to train a generative model. Second, disclosed embodiments may use only the output of the expert system as music training data (in contrast to comparing output of an expert system with another dataset such as professional music recordings). Further, disclosed techniques may use user feedback to tell the generative model which music from the expert system is the “best.” Still further, disclosed techniques may utilize a user feedback model to simulate user feedback to reduce human appraisal requirements.

### Introduction to Granular User Feedback Tracking and User Profiles

Further, disclosed embodiments described with references to FIGS. 5A-9 provide highly granular user feedback information, which may be used to fine-tune generative music systems for specific users or groups of users. For example, the AiMi system may provide “Sonic DNA” profile information for a given user based on interactions by that user with generated music. Note that the feedback/profile information may be utilized for both expert system implementations and machine learning model implementations. But, as discussed above, a machine learning model may be better qualified to integrate various detailed feedback information discussed herein.

In some embodiments, in response to explicit or implicit user feedback, the system is configured to create or update various information for that user, such as information relating to: liked loops, disliked loops, like mixes, disliked mixes, liked sections, disliked sections, genre listening times, artist listening times, etc. Various of these examples may include additional specific information. For example, the system may generate or retrieve various features of a liked loop/mix (e.g., brightness, range, etc.), a contrastive-model-generated, multi-dimensional embedding used to gauge the similarity of the loop/mix with other loops/mixes, etc. This granular information may advantageously improve customization by the generative system for a particular user.

As the generative system navigates a highly complex multi-dimensional space to select loops and control mix decisions, various aggregated detailed use profile information may be useful as input vectors to steer generative music to meet user preferences. In embodiment with generative machine learning models, disclosed user profile techniques may allow the model to remain generic to multiple users, but still generate user-customized music based on input of detailed profile information to the model during composition.

In some embodiments, more recent feedback is emphasized, e.g., to allow users to recognize the impact of their feedback immediately (e.g., because slow changes to a user profile over time may not provide short-term changes in composition). Further profile information for different users may be shared, aggregated, or both.

### Examples of Training Generative Models Using Expert System

Speaking generally, traditional techniques for creating music using end-to-end generative audio processes may have limits on music quality and steerability. Further, traditional techniques may require very large datasets.

As mentioned above, in the context of the AiMi system, developers have built a library of stylistically appropriate and quality loops and designed an expert system to arrange loops into highly listenable and high-fidelity continuous music.

In disclosed embodiments discussed herein, a computing system trains generative models on streams from these expert systems, based on both the audio generated by the expert systems and decisions (e.g., relating to loop selection, combining, and mixing) made by the expert systems.

In some embodiments, a classifier is trained to predict whether or not music was generated by humans and the expert systems may attempt to trick the classifier. The expert systems may then be refined using reinforcement learning. In order to improve training of the generative machine learning model based on output of the expert systems, only the outputs that were “best” at tricking the classifier (or human reviewers) into believing that the compositions were human-generated may be used to train the model. (Or the classifier output may be an input to the training system, for use in determining current quality of the composition by the expert system).

After an initial training phase, a second training phase may refine the trained model to even surpass the quality of music generated by the expert systems, e.g., based on user feedback. Further, the model may be refined to personalize generated music beyond the personalization capabilities of the expert systems. A user profile model or user feedback model may be trained to predict user feedback for the second training phase, which may further reduce human interaction in training.

This approach may allow development with smaller datasets to solve problems that machine learning models are slow and less effective to train for (e.g., processes of music construction that music experts can explain or quantify in detail, that can be implemented in the expert systems). For example, the machine learning aspect may instead focus on complex structures within music that are harder to explain or quantify. This may include aspects of music that producers, creators and listeners alike have preferences about and utilize, but can't clearly explain why they like or use them.

This may in turn reduce the scale of data required to start learning more complex structures. Further, the expert systems may provide a large and continuously growing dataset of music for training purposes.

Further, music produced by the expert systems may have enough utility for a wide audience to invite significant participation in feedback processes. For example, the free-to-use listening on the Aimi app and website is enjoyable to listen to and interact with, providing explicit feedback (thumbs up/down) and implicit feedback (which experiences are listened to, for how long, which mixing adjustments are made).

The disclosed techniques may utilize a multi-modal approach that allows for modularization and incremental advancement. In particular, mixed audio, processed mixed audio (e.g., spectrograms), unmixed tracks (stems), loops, loop features, and expert system commands may be utilized as inputs during training and in production systems.

Disclosed techniques may allow analysis of mixed audio and correlation of loop features with user feedback (e.g., biasing the generator to select loops with certain features for a particular user), correlating expert system commands with unmixed tracks (which may develop differential neural processes to replace specific commands, providing steerability), and generating new loops with features that affect mixed audio in desired ways.

Turning now to FIG. 1, a block diagram of training system 100 configured to initially train a generative model to generate music similar to an expert system is shown. System 100 includes a set of components that may be implemented via hardware or a combination of hardware and software routines. In the illustrated embodiment, training system 100 includes expert system 110, performance systems 120A and 120B, training control 130, and machine learning model 140. In some embodiments, system 100 is implemented differently than shown. For example, performance system 120B may be deployed as part of machine learning model 140.

Expert system 110, in various embodiments, is software executable to generate composition decisions 115A. Composition decisions 115 may include loop selection (or characteristics of loops to be selected), layering decisions, mixing decisions (e.g., applying effects, gain adjustments, pitch shifting, etc.), and so on. In the illustrated example, expert system 110 provides composition decisions 115A to performance system 120A. Composition decisions 115A may be sufficient for performance system 120A to generate audio data 125A (e.g., raw MIDI data).

Machine learning model 140, in various embodiments, is software executable to generate composition decisions 115B. Similarly, machine learning model 140 provides composition decisions 115B to performance system 120B. Model 140 may be a neural network, for example, or any of various other appropriate machine learning structures. Model 140 may have input nodes that receive input vectors for training and production, one or more internal layers, and decision nodes that provide binary or statistical decisions for various decisions (e.g., different loop characteristics, composition decisions such as the number of loops, effects decisions, etc.). Nodes in the machine learning model may implement various appropriate equations and may utilize weights that are adjusted during training.

Training control 130, as shown, receives audio data 125A and 125B from performance systems 120A and 120B, respectively. In some embodiments, training control 130 may receive processed audio data, e.g., spectrogram data, classification outputs, etc. As shown, training control 130 receives composition decisions 115A from expert system 110 and composition decisions 115B from machine learning model 140. This information may allow improved training speed and accuracy, relative to training only on the output audio data or on professional compositions. Training control 130 provides a training data input vector to machine model 140 and also generates model updates 135.

For example, training control 130 may update the model 140 based on a difference (e.g., a Euclidean distance in a multi-dimensional output vector space) between outputs of machine learning model 140 and performance system 120B and outputs of expert system 110 and performance system 120A.

The training data input vector 145 may include various vector fields, such as, without limitation: features from recent loops (e.g., as extracted by an AI loop classifier (not shown) in real-time or pre-generated), user feedback, user profile, current conditions (e.g., environment information, location data, etc.), recent raw audio, recent processed audio, simulated user feedback, etc. Note that the training data input vector 145 (and production vectors to machine learning model 140 after training) may incorporate a larger number of features than external/internal inputs to the algorithms of expert system 110. Thus, model 140 may be able to handle more complexity and may have more flexibility and steerability than the expert system 110.

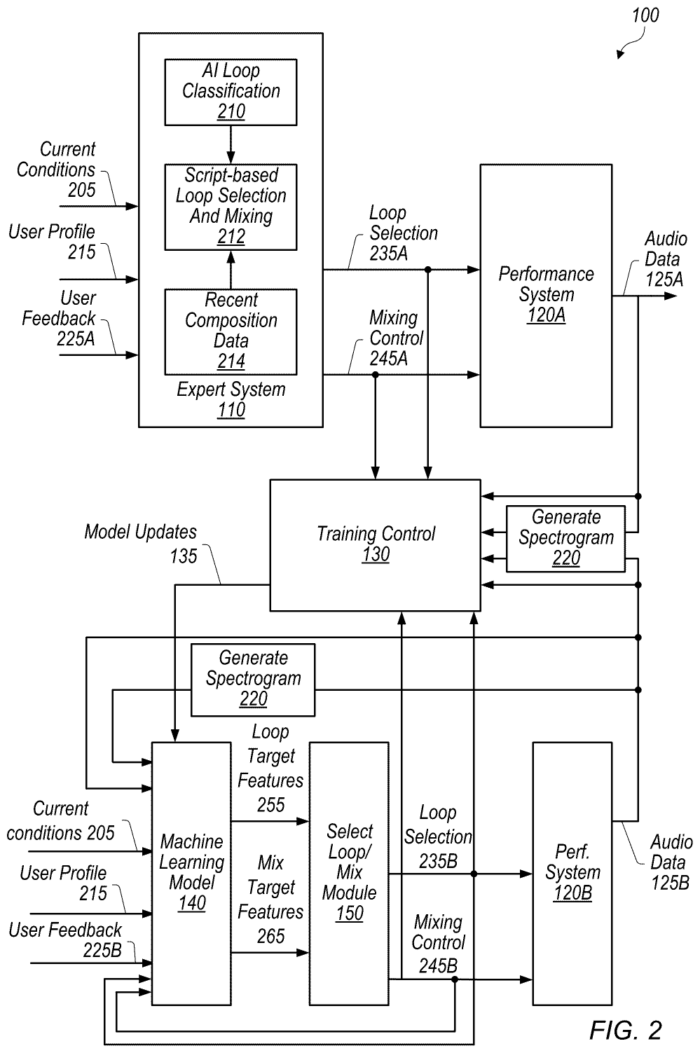

Turning now to FIG. 2, a more detailed block diagram of training system 100 configured to initially train a generative model to generate music similarly to an expert system is shown, according to some embodiments. System 100 includes a set of components that may be implemented via hardware or a combination of hardware and software routines. In the illustrated embodiment, training system 100 includes expert system 110, performance system 120A and 120B, training control 130, machine learning model 140, and select loop/mix module 150. As shown, expert system 110 further includes AI loop classification 210, script-based loop selection and mixing 212, and recent composition data 214.

In the illustrated example, expert system 110 receives current conditions 205, user profile 215, and user feedback 225A. Current conditions 205, in some embodiments, includes one or more of: lighting information, ambient noise, user information (facial expressions, body posture, activity level, movement, skin temperature, performance of certain activities, clothing types, etc.), temperature information, purchase activity in an area, time of day, day of the week, time of year, number of people present, weather status, etc. For example, expert system 110 may determine that a user is currently exercising based on their current activity level, and as a result, expert system 110 may select a set of loops associated with higher activity levels. In some embodiments, current conditions 205 is used to adjust one or more stored rule set(s) to achieve one or more environment goals. Similarly, expert system 110 may use current conditions 205 to adjust stored attributes for one or more audio files, e.g., to indicate target musical attributes or target audience characteristics for which those audio files are particularly relevant. In some embodiments, a user may specify the current conditions 205 based on their desired energy level and/or mood. For example, a user may specifically request expert system 110 to generate a mix for an activity, such as meditation.

User profile 215, in various embodiments, is a collection of data, preferences, and settings associated with a particular user and is used by expert system 110 to generate customized loop selections 235A and mixing controls 245A for the particular user. For example, a user may prefer a particular genre of music, such as techno, and loops with low brightness, and accordingly, expert system 110 may generate loop selection 235A and mixing control 245A based on those preferences. In some embodiments, user profile 215 may be a representation, such as an embedding, that represents musical expressions and/or compositions preferred by a particular user. For example, as a user provides user feedback 225, the “liked” loops may be mapped to a vector space such that expert system 110 may select other loops within a set distance from the liked loops. User profile 215 is discussed in greater detail with respect to FIG. 5A.

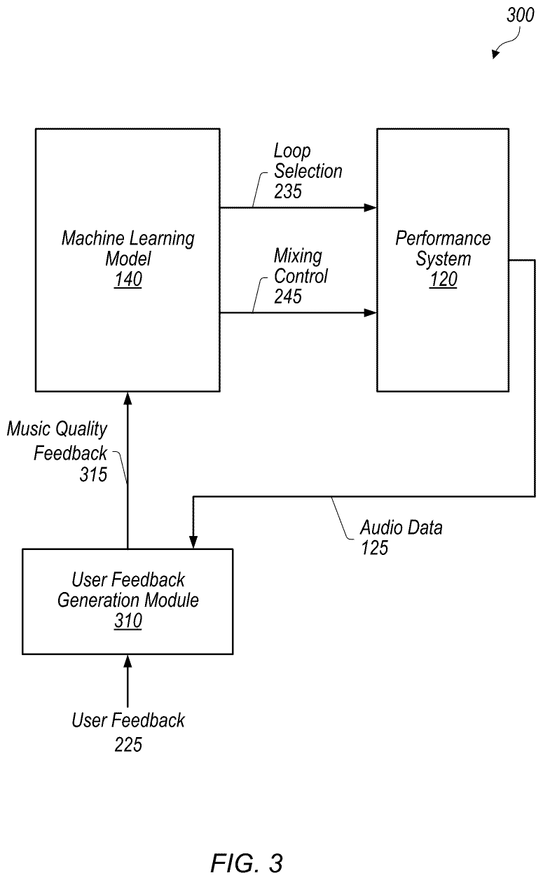

User feedback 225A, in various embodiments, is data collected from a user describing their experience associated with audio data 125A and is direct or indirect. Direct user feedback 225 refers to feedback provided by a user and may be collected through surveys, questionnaires, thumbs up/down controls, numerical ratings, star ratings, comment boxes, etc. For example, a user may interact with a user interface (UI) to submit a thumbs down while listening to audio data 125A. Indirect user feedback 225A refers to feedback inferred from a user based on their behavior, patterns, and/or other indirect indicators. In some embodiments, indirect user feedback 225A may be collected via a biometric sensor, such as a camera, to determine whether a user is expressing a particular type of emotion. For example, expert system 110 may determine a user is smiling, via a biosensor, while listening to a particular loop, and as a result, expert system may generate positive user feedback for the particular loop. In some embodiments, indirect user feedback 225A may be collected from additional metrics, such as listening time, audio volume levels, etc. For example, expert system 110 may generate positive user feedback 225 if the user continues to listen to a particular combination of loops with a similar set of features. In some embodiments, user feedback 225 is synthetic user feedback. Synthetic user feedback is discussed in greater detail with respect to FIG. 3. User profile 215 and user feedback 225A and 225B may be used to indicate the quality of the music from the expert system compared to machine learning model 140.

Note that in some embodiments model 140 may be trained with user profile information 215 as an input and not user feedback 225 (which may be incorporated during a later training stage or may be handled by a different module to update user profile information 215 over time).

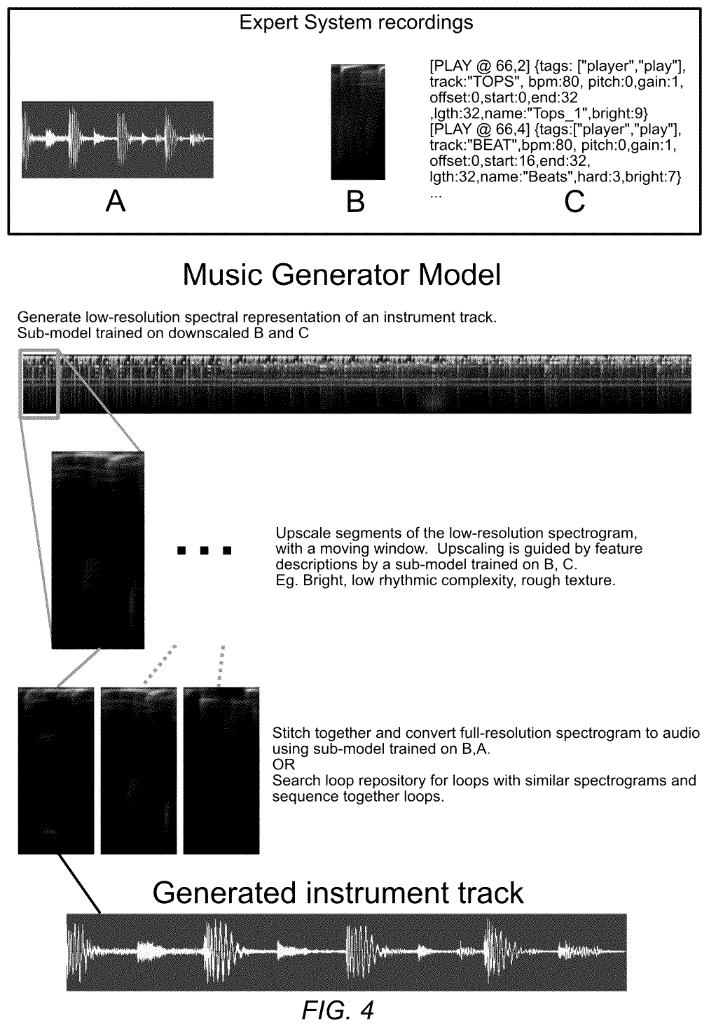

In the illustrated embodiment, model 140 also receives spectrogram data as an input from module 220, e.g., one or more spectrograms for one or more windows of output audio data 125B. In some embodiments, model 140 outputs spectrogram information, e.g., for use in selecting loops with similar spectrograms. Detailed example spectrograms are shown in FIG. 4. In other embodiments, model 140 outputs vectors that represent other target loop characteristics.

As shown, expert system 110 includes AI loop classification 210, script-based loop selection and mixing 212, and recent composition data 214. AI loop classification 210, in various embodiments, is software executable to compute values for features associated with a loop. A feature is a characteristic that is extracted from a loop and/or combination of loops, such as brightness, hardness, groove, density, range, and complexity, and may be represented as a numerical value. For example, AI loop classification 210 may compute a brightness score within a range of 0 to 100 for a particular loop and store the computed value associated with the particular loop. Example features are discussed in greater detail with respect to FIG. 5A. In some embodiments, AI loop classification 210 classifies the audio loop by the type of instrument. For example, AI loop classification 210 may classify a loop as being performed by a trumpet. AI loop classification 210 may further classify a loop by genre. For example, AI loop classification may classify a guitar audio loops as a rock audio loop. Recent composition data 214, in various embodiments, is data that describes the previous loop selection 235A and mixing control 245A. Recent composition data 214 information about one or more audio files including: feature values, tempo, volume, energy, variety, spectrum, envelope, modulation, periodicity, rise and decay time, noise, artist, instrument, theme, etc. Note that, in some embodiments, audio files are partitioned such that a set of one or more audio files is specific to a particular audio file type (e.g., one instrument or one type of instrument). For example, recent composition data 214 may describe a loop with a brightness value of 20 and complexity value of 35, and accordingly, expert system 110 may uses these values to determine to select similar or dissimilar loops. Note that various loops and loop classification information may be available to model 140 during training, in addition to the expert system.

Script-based loop selection and mixing module 212, in various embodiments, is a software executable to generate loop selection 235A and mixing control 245A based on current conditions 205, user profile 215, user feedback 225A, recent composition data 214, and AI loop classification 210. Script-based loop selection and mixing 212 accesses stored rule set(s). Stored rule set(s), in some embodiments, specify rules for how many audio files to overlay such that they are played at the same time (which may correspond to the complexity of the output music), which major/minor key progressions to use when transitioning between audio files or musical phrases, which instruments to be used together (e.g., instruments with an affinity for one another), etc. to achieve the target music attributes. Said another way, script-based loop selection and mixing 212 uses stored rule set(s) to achieve one or more declarative goals defined by the target music attributes (and/or target environment information). In some embodiments, script-based loop selection and mixing 212 includes one or more pseudo-random number generators configured to introduce pseudo-randomness to avoid repetitive output music. Loop selection 235A and mixing control 245A are examples of decisions by the expert system, but various composition decisions may be implemented. As shown, expert system 110 provides loop selection 235A and mixing control 245A to performance system 120A.

Performance system 120A, in various embodiments, is software executable to generate audio data 125A from loop selection 235A and mixing control 245A. Audio data 125A is a digital representation of analog sounds, such as an audio file. In some embodiments, image representations of audio files, such as a spectrogram, are generated and used to generate music content. Image representations of audio files may be generated based on data in the audio files and MIDI representations of the audio files. The image representations may be, for example, two-dimensional (2D) image representations of pitch and rhythm determined from the MIDI representations of the audio files. Rules (e.g., composition rules) may be applied to the image representations to select audio files to be used to generate new music content. In various embodiments, machine learning/neural networks are implemented on the image representations to select the audio files for combining to generate new music content. In some embodiments, the image representations are compressed (e.g., lower resolution) versions of the audio files. Compressing the image representations can increase the speed in searching for selected music content in the image representations. As shown, the expert system may not utilize spectrogram data but model 140 may receive this information as part of the input vector for both training and production. The spectrogram information may allow the model 140 to learn what a “good” spectrogram looks like, for a given scenario, during training.

Machine learning model 140, in various embodiments, is software executable to generate a set of target features for a loop and/or mix in order to create music compositions based on extracted features 255, current conditions 205, user profile 215, and user feedback 225B. For example, machine learning model 140 may output vectors that indicate characteristics of loops to be selected and vectors that indicate how to combine and augment selected loops. Machine learning model 140 may generate loop target features 255 and mix target features 265 using a variety of techniques and may be trained to generate those outputs similarly to expert system 110.

Machine learning model 140, in some embodiments, is a loop sequencing transformer that can produce one or more beat embeddings from a section of beats, using positional encoding, a self-attention layer, and a dense layer. A beat embedding, in various embodiments, is a vector representation based on the features of audio within a sequence and is associated with a unique timestamp. For example, a beat embedding may represent a weighted average value of features from a combination of loops at a particular timestamp within a sequence of beats. In various embodiments, machine learning model 140 processes the sequence of beat embeddings in parallel and, to preserve their ordering, adds positional encodings to the input embeddings based on their respective unique timestamps. For example, a particular beat may be the 48th beat in a section of music, and machine learning model 140 utilizes positional encoding to reflect its position within the section. Machine learning model 140 may thus be described as predicting the values for the features of the beat embedding in the next timestamp based on the features of the beats from the previous timestamp(s) (e.g., to match results output by expert system 110). In some embodiments, the predicted values of the features of a particular timestamp are derived using the values of the embedding from only the preceding timestamp.

In some embodiments, disclosed beat embedding techniques may be used in conjunction with spectrogram techniques discussed below with reference to FIG. 4. For example, in some embodiments, a diffusion model may generate loops to match target features generated by model 140 (e.g., instead of selecting from a library of existing loops). For example, the diffusion model my generate a spectrogram from one or more downscaled spectrograms. Downscaled spectrograms may be generated by a sub-model and upscaling performed by another sub-model, in some embodiments. In some embodiments, the generative system may therefore combine transformer and diffusion models.

Select loop/mix module 150, in various embodiments, is software executable to generate loop selection 235B and mixing control 245B based on loop target features 255 and mix target features 265. Generally, module 150 is configured to process machine learning outputs from model 140 and translate those outputs to composition actions for performance system 120B. Based on the values from loop and mix target features 255 and 265, module 150 may search a loop repository to locate prerecorded audio loops with similar features or control a loop generator module (not shown) to generate loops that match desired target features. As shown, module 150 provides loop selection 235B and mixing control 245B to performance system 120B. As previously discussed with performance system 120A, performance system 120B is software executable to generate audio data 125B from loop selection 235B and mixing control 245B.

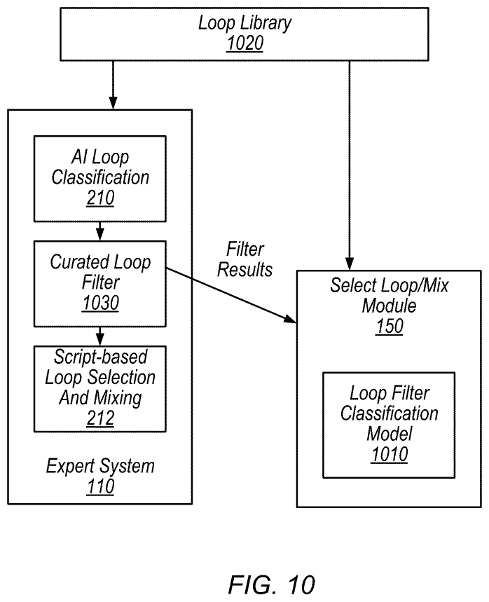

In some embodiments, module 150 includes a classification module that is trained based on information from expert system 110 regarding which loops should be considered for inclusion (e.g., in certain genres, for certain artists, etc.). These embodiments are discussed in more detail below with reference to FIG. 10. Speaking generally, module 150 may include one or more rules-based components, one or more machine learning components, or both. In embodiments in which model 150 includes machine learning components, training control 130 or another training module may train those components to behave similarly to rules-based components of expert system 110.

Training control 130, in various embodiments, is software executable to generate model updates 135 (e.g., adjusted weights) for machine learning model 140. In some embodiments, training control 130 may calculate a similarity score using a similarity function, such as cosine similarity or Euclidean distance. A similarity score represents the level of similarity for a comparison between the outputs from expert system 110 with the outputs of machine learning model 140. For example, training control 130 may generate a score, indicating that the outputs are dissimilar. After calculating the similarity scores for a given output of expert system 110 and machine learning model 140, training control 130 may use a loss function, such as a symmetric cross entropy loss function, to calculate a loss value. This loss value represents the error between the outputs of the expert system 110 and machine learning model 140. Based on the loss value, training control 130 adjusts the set of weights, using backpropagation, to minimize the loss value. Backpropagation is a technique for propagating the total loss value back into the neural network and adjusts the weights of machine learning model 140 accordingly. By adjusting the weights, training control minimizes the distance (e.g., Euclidean distance) of the outputs in the embedding space until an acceptable loss value is achieved.

Note that while training control 130 receives inputs 235A-235B and 245A-245B in the illustrated embodiment, in other embodiments training control 130 may receive other inputs, such as loop target features 255 and mix target features 265 (along with similar information from expert system 110, e.g., determined by module 212).

The inputs to training control 130 may be provided as individual inputs (and may be provided periodically or asynchronously) or may be buffered and aggregated over various appropriate windows.

Note that the modularity of various elements of FIG. 2 may be advantageous in various scenarios. For example, in some embodiments, the loop selection 235B, mixing control 245B, or both are suggestions for performance system 120B. For example, the suggestions may be provided as an ordered list and the performance system 120B may select the first item of the list by default, but users may select from other options on the list for upcoming decisions (e.g., the next section, inclusion of certain loops/tracks, etc.). Similar techniques may be applied to various communications between elements of FIG. 2, e.g., to allow user input to the loop selection, composition decisions, or both in production environments.

Further note that the system of FIG. 2, due to a well-designed expert system, may allow training of model 140 without positive feedback. Rather, it may be assumed that music is of listenable quality in the absence of negative feedback (e.g., and a small positive reward may be given to the model for decisions that did not have explicit feedback). This may allow the model to be trained without human-in-the-loop processes (although human input may be beneficial when available). Therefore, in some embodiments, the system may omit user feedback 225B and model 140 may be trained without human feedback in one or more stages of training.

### Example Techniques to Generate Synthetic User Feedback

Turning now to FIG. 3, a block diagram of system 300 configured to generate music quality feedback is shown. System 300 includes a set of components that may be implemented via hardware or a combination of hardware and software routines. In the illustrated embodiment, system 300 includes machine learning model 140, performance system 120, and user feedback generation module 310.

User feedback generation module 310, in various embodiments, is configured to provide music quality feedback to machine learning model 140. In some embodiments, module 310 simply passes user feedback to model 140 based on actual user feedback received in response to the audio data 125. In other embodiments, module 310 is configured to train a machine learning model to generate synthetic user feedback based on received audio data 125. For example, the model may learn what music human users like and provide positive feedback to that music. Similarly, the model may learn what music is considered “good” in a particular genre and provide feedback on audio data 125 created for that genre. This may allow humans to be removed from the training loop once a user feedback machine learning model has been trained.

The user feedback model may be a neural network, for example, that receives vectors representing audio data 125 or characteristics of audio data 125 as an input and generates output vectors that represent whether synthetic user feedback is being generated and the type of feedback being generated, for example.

In some embodiments, module 310 implements a neural network. Note that module 310 may allowed continued training of model 140 after it is initially trained to mimic an expert system, which may allow the model 140 to generate even “better” music than the expert system, e.g., due to its ability to learn more complex aspects of composition than the expert system. Further, module 310 may be used with expert system 110 prior to training model 140, e.g., to sort out a subset of the “best” music to be used to train model 140.

### Example Diffusion Techniques for Loop Generation

FIG. 4 is a diagram illustrating example recorded data from an expert system, including MIDI data A, spectrogram data B, and decision data (e.g., a performance script) C, used to train machine learning model 140. Note that the MIDI data is an example of audio data 125A, spectrogram data is an example of an output of module 220 of FIG. 2 and the decision data is an example of loop selection 235A, mixing control 245A, or both. In some embodiments, a loop generator machine learning model (e.g., a diffusion model) is configured to upscale low-resolution spectrograms to generate loops with target features. The full resolution spectrograms create new, stylistically suitable loops based on the features provided by expert system 110.

In some embodiments, machine learning model 140, another model, or some combination thereof generates a low-resolution spectral representation of an instrument track. As shown, the diffusion model may upscale segments of the low-resolution spectrogram using a moving window. The upscaling may be based on training using down-scaled spectrogram data B from the expert system, original or downscaled data from the decision data C, or both.

The system may then stitch together and convert the results to a full-resolution spectrogram and use the full-resolution spectrogram to generate an instrument track. In other situations or embodiments, the system may search a loop repository for loops with similar spectrograms.

The system may transform the spectrogram by progressively introducing noise, resulting in a noisy version of the original spectrogram. For example, machine learning model 140 may lower the resolution of the original spectrogram, resulting in a low-resolution spectral representation of an instrument track. In some embodiments, noise may be added until the original features of the spectrogram are completely obscured by noise. The low-resolution spectrograms may provide a simple and conceptually clear representation of audio that can be edited by hand. For example, an application may allow creators to draw in notes and beats and have them synthesized or used for searching the loop repository. In some embodiments, noise may be added to spectrograms by a separate model, such as training control 130.

As part of generating new spectrograms, machine learning model 140 reverses the process in an attempt to reconstruct the spectrogram. For example, machine learning model 140 may receive a low-resolution spectrogram, and accordingly, machine learning model 140 attempts to upscale the spectrogram. Segments of the low-resolution spectrogram may be upscaled with a moving window and guided by feature descriptions provided by data C. Accordingly, the windows may be stitched together to create a new spectrogram. One or more machine learning models may be initially trained on expert system recordings for detail recovery and stylistically appropriate texture filling of upscaled and converted audio, but the model may be able to reverse the diffusion process for randomly generated low-resolution spectrograms. For example, a trained machine learning model 140 may be able to denoise spectrograms provided by external applications. In some embodiments, machine learning model 140 provides the spectrogram to select loop/mix module 150, and module 150 may search a loop repository for loops with similar spectrograms. Various disclosed techniques may provide a full instrument loop which may be mixed with other loops.

Note that, in embodiments in which model 140 is configured to output spectrogram information, this information may be directly provided to training control 130 instead of generated by module 220.

### Example Techniques for Generating User “Sonic DNA” Profiles Based on Feedback

Turning now to FIG. 5A, a block diagram of system 500 configured to generate composition decisions 115 based on embeddings for a user profile is shown. System 500 includes a set of components that may be implemented via hardware or a combination of hardware and software routines. In the illustrated embodiment, tensor generator/extractor module 510 provides embeddings for user profile information 520, which is used as input vector(s) to machine learning model 140 e.g., to generate customized music for a user. Note that user profile information 520 is one example of the user profile data 215 discussed above with reference to FIG. 2.

As used herein the term “embedding” refers to a lower-dimensional representation of a higher-dimensional set of values. For example, various aspects of a musical expression may be processed to generate a single “brightness” value in a range from 0 to N.

User profile information 520, in various embodiments, represents a set of features for musical expressions and/or compositions preferred by a particular user. For example, user profile information 520 may represent an aggregation of features that is computed based on feedback provided by the user.

As shown in the illustrated embodiment, tensor module 510 receives user feedback at point(s) in time during composition 502 and also receives corresponding current composition parameters/details 504. User feedback 502, in various embodiments, is data collected from a user about their experience for a composition at a particular point in time. For example, a user may provide explicit positive or negative feedback associated with the current composition. User feedback 502 may be provided via a user interface (UI), such as a clickable button, and may be associated with a timestamp and the composition performed at the timestamp. User feedback 502 may be collected through surveys, questionnaires, thumbs up/down controls, numerical ratings, comment boxes, etc. User feedback may also be implied by various user actions that are not explicitly feedback (e.g., volume changes, time spent listening without a change, biometric information, etc.). Textual user feedback 502 may be processed by a natural language processing model prior to being provided to module 510. In some embodiments, user feedback 502 may be synthetic and created using various machine learning techniques, e.g., as discussed above with reference to FIG. 3. For example, user feedback 502 may be generated by a machine learning model trained on composition/feedback pairs provided by a plurality of users.

Current composition parameters/details 504, in some embodiments, is metadata describing the current composition, e.g., based on the compositions decisions 115 generated by machine learning model 140, audio data 125B, or both. Therefore, information 504 may include various data from loop target features 255, mix target features 265, loop selections 235B, mix control signals 245B, audio data 125B, etc., or some combination thereof. Therefore, current composition parameters/details 504 may be a set of features that describe target attributes for loops within the current composition, selected loops, the overall mix itself, or some combination thereof. Therefore, current composition parameters 504 may identify loops, specify features of loops or the mix, etc. Module 510 may lookup various features of the loops/mix or process the loops/mix to generate the embeddings 512 and 514.

Tensor generator/extractor module 510, in various embodiments, is software executable to generate expression embedding 512 and composition embedding 514 based on user feedback 502 and current composition parameters/details 504. The expression embedding 512 relates to a single musical expression while the composition embedding 514 relates to the overall mix. Note that multiple expression embeddings may be generated based on a single instance of user feedback, e.g., for multiple loops included in the current mix.

As one example of expression embedding 512, module 510 may map determined features of a musical expression as a vector in a multi-dimensional space based on the features' respective values indicated by the current composition parameters/details 504. For example, expression embedding may include a 2D embedding of a loop from a contrastive model (discussed below with reference to FIG. 8) and values for: brightness, hardness, groove, density, range, complexity, etc. Module 510 may lookup these vectors (e.g., in a library) or process the loop to generate these vectors. Module 510 may generate a similar embedding 514 for the overall mix. Accordingly, embedding 512 and 514, in some embodiments are vector representations for a number of features extracted from a musical expression.

As part of generating composition embedding 514, module 510 may map a set of features for a combination of musical expressions (composition) as a vector in a multi-dimensional space. As one example, module 510 may average values associated with the different loops included in the composition (e.g., averaging multiple expression embeddings 512). For example, if the musical composition includes a combination of three musical expressions with average groove values of 85, 60, and 65, the groove value for the mix may be 70. Generally, composition embedding 514 may be a vector representation for N number of features of an overall mix of multiple musical expressions.

In other embodiments, module 510 may process the overall mix to directly generate various features for composition embedding 514. For example, module 510 may run the mix through training module 820 discussed in detail below, or through one or more models configured to extract features such as brightness, etc. Therefore, module 510 may determine one or more features of embedding 514 independently of features of embedding 512.

As mentioned above, example values that may be included in an embedding include brightness, hardness, groove, density, range, and complexity, and may be represented as numerical values within a range. Brightness refers to the level of frequency of a loop or combination of loops. For example, a loop with a higher frequency may be assigned a higher brightness score. Hardness refers to the aggressiveness of a loop or combination of loops. For example, a loop may include a techno bass that is considered more aggressive, and thus, the loop is assigned a higher hardness score. Groove refers to the “grooviness” or rhythmic structure (e.g., swing) of a loop or combination of loops. For example, a loop may include a robotic techno beat that is considered less groovy, and thus, the loop is assigned a lower groove score. Density refers to a combination of texture and rhythmic density of a loop or combination of loops. For example, a loop may include a higher number of notes per beat and is considered denser, and thus, the loop is assigned a higher density score. Range refers to the distance between the lowest and highest pitch in a loop or combination of loops. For example, a loop that includes low and high notes is considered to have a larger range, and thus, the loop is assigned a higher range value. Complexity refers to the tonal complexity of a loop or combination of loops. For example, a loop that includes a chord with seven different notes is considered more complex, and thus, the loop is assigned a higher complexity score. In some embodiments, embedding features may include additional information such as boominess, warmth, genre, vocals, instrumentation, loop type, etc.

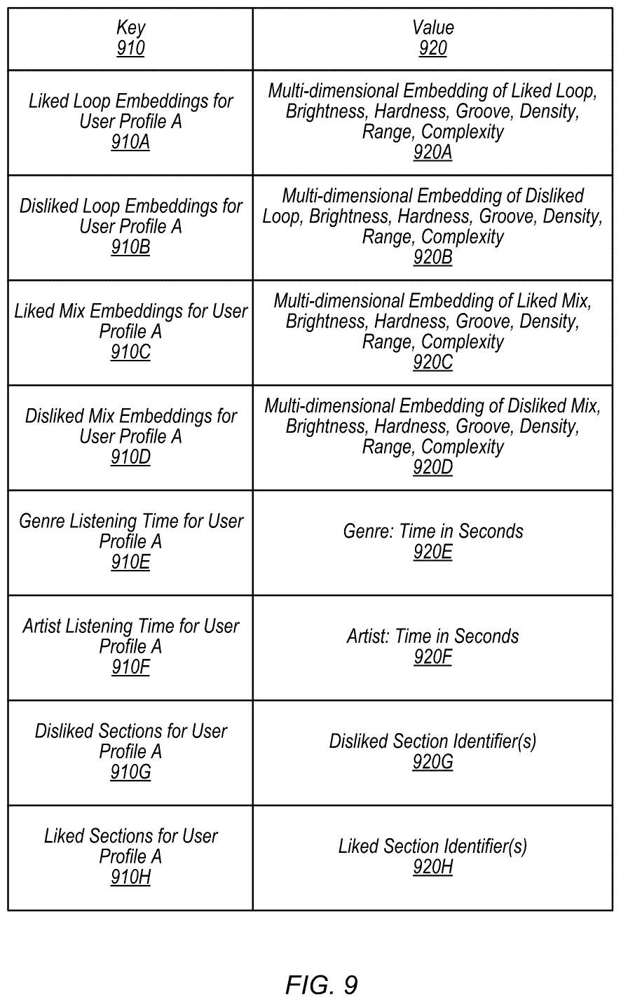

As shown, expression embedding and/or composition embedding 514 are stored as embeddings from user feedback 530 in user profile information 520. Note that a detailed non-limiting example of user profile information 520 is shown in FIG. 9, discussed in detail below. Further, in some embodiments, user profile information 520 may include additional information such as the identity of a user, location information, age, gender, etc. As shown, user profile information 520 is provided to machine learning model 140, and model 140 evaluates user profile information 520 as part of generating composition decisions 115.

Note that module 510 may also store embeddings 530 that are not generated based on explicit user feedback. For example, module 510 may generate embeddings based on time listened to a genre, time listened to an artist, etc. Further, module 510 may directly store identifying information rather than mapping features, e.g., by storing information identifying section identifiers for musical sections liked by the user, etc.

Note that embeddings 530 may be averaged for a particular user or maintained independently. For example, the composition embeddings 514 generated at different times for a user (based on feedback at different times) may be averaged for storage or may be stored separately and potentially processed before being provided to machine learning model 140. In some embodiments, certain embeddings (e.g., more recent embeddings) may be given greater emphasis, as discussed in detail below.

### Example Emphasis Techniques for Recent User Feedback

FIG. 5B is a block diagram of a more detailed example of the system 500 of FIG. 5A with an example emphasis implementation, according to some embodiments. System 500 includes a set of components that may be implemented via hardware or a combination of hardware and software routines. Various elements may be configured as discussed above with reference to FIG. 5A. In addition, the system of FIG. 5B stores multiple sets of embeddings 532 and 534 in user profile information 520 and includes aggregation module 540.

More recent embedding 534 may be given greater emphasis that previous feedback 532. Embeddings may be moved from recent embeddings 534 to previous embeddings 532 based on a timeout interval, for example. For example, a particular recent loop embedding 546 may be reclassified as an older loop embedding 542 after 24 hours. In some embodiments, recent embeddings 546 and 548 may be reclassified as older embeddings 542 and 544, respectively, after user profile information 520 receives a set number of embeddings 516 and 518 from module 510. For example, a particular recent mix embedding 548 may be reclassified as older mix embedding 544 in response to user profile information 520 receiving five newer mix embeddings 518 from module 510. Recent embeddings 546 and 548 and older embeddings 542 and 544 are provided to aggregation module 540.

Aggregation module 540, in various embodiments, is software executable to aggregate older loop embeddings 542 and recent loop embeddings 546 into an aggregated loop embedding 552, and aggregate older mix embedding 544 and recent mix embedding 548 into an aggregated mix embedding 554. Aggregated loop embedding 552 may be an average or weighted average of one or more recent loop embeddings 546 and one or more older loop embeddings 542. For example, recent loop embeddings 546 may be considered more important than older loop embeddings 542, and as a result, recent loop embeddings 546 are weighted differently when determining aggregated loop embedding 552. Similarly, aggregated mix embedding 554 may be an average or weighted average of one or more recent mix embeddings 548 and one or more older mix embeddings 544.

In some embodiments, aggregation module 540 may generate an aggregated “liked” loop embedding 552A and an aggregated “disliked” loop embedding 552B based on the type of user feedback 502. For example, aggregation module 540 may aggregate a plurality of liked recent loop embeddings 546 and liked older loop embeddings 542 into a liked aggregated loop embedding 552. Similarly, aggregation module 540 may generate an aggregated “liked” mix embedding 554A and an aggregated “disliked” mix embedding 554B based on the type of user feedback 502.

Note that, while not explicitly shown, separate loop embeddings may be maintained for a given user for different types of tracks, e.g., different instruments in various embodiments.

As part of computing aggregated loop and/or mix embedding 552 and 554, aggregation module 540, in various embodiments, applies “emphasis” to loop embedding 516 and/or mix embedding 518 based on their respective classification (e.g., recent). Emphasis adjusts the importance of loop embedding 516 and mix embedding 518, resulting in an emphasized (e.g., weighted) version of loop embedding 516 and mix embedding 518. For example, the emphasized version of loop embedding 516 may be weighted such that it contributes more to aggregated loop embedding 552 relative to other loop embeddings 516. In some embodiments, emphasis may be applied by aggregation module 540 or a separate machine learning model. Example data structures for tracking emphasis are discussed in greater detail with respect to FIG. 5C.

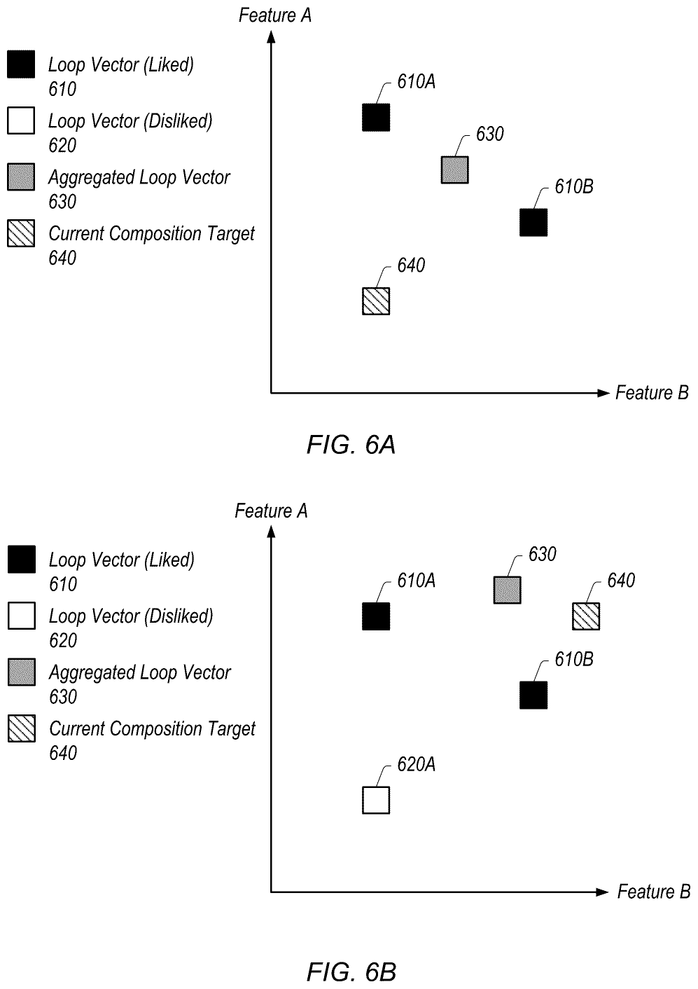

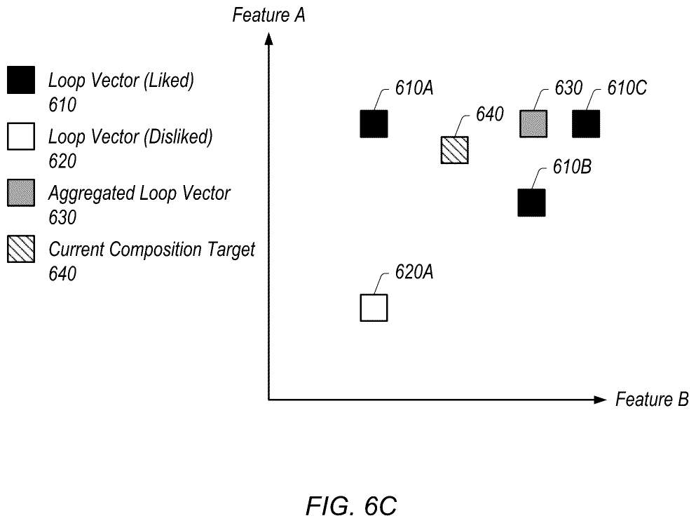

As shown, aggregated loop embedding 552 and aggregated mix embedding 554 are provided to machine learning model 140. Machine learning model 140, in various embodiments, generates compositions decisions 115 based on the position of aggregated embeddings 552 and 554 in the embedding space. For example, machine learning model 140 may select a particular loop located within a set proximity of liked aggregated loop embedding 552 as part of generating composition decisions 115. An example showing loop embeddings 516 in a simplified embedding space is discussed with respect to FIG. 6A-C.

Turning now to FIG. 5C, a diagram illustrating example data structure fields used to track emphasis assigned to loop and mix embeddings is shown. In the illustrated embodiment, loop embeddings 516A-N have a corresponding loop emphasis 562A-N, respectively, and mix embeddings 518A-N have a corresponding mix emphasis 570A-N, respectively. Loop emphasis 560, in various embodiments, reflects the level of importance of loop embedding 516, resulting in a weighted version of loop embedding 516. Accordingly, loop emphasis 560 affects the impact of a given loop on the position of aggregated loop embedding 552 in the embedding space. For example, a particular loop embedding 516 with a relatively greater emphasis may cause the position of aggregated loop embedding 552 to shift further in the direction of the particular loop embedding 516. Mix emphasis 570, in various embodiments, adjusts the level of importance of mix embedding 518, resulting in a weighted version of mix embedding 518. Accordingly, mix emphasis 570 affects the position of aggregated mix embedding 554 in the embedding space. For example, a particular mix embedding 518 may be weighted differently relative to other mix embeddings 518 such that the position of aggregated mix embedding 552 is shifted more strongly away from the particular mix embedding 518.

The values for loop emphasis 560 and/or mix emphasis 570 may be determined based on a variety of factors. In various embodiments, loop emphasis 560 and/or mix emphasis 570 may be associated with a timestamp and decay based on the value of the timestamp. Loop emphasis 560 and mix emphasis 570 may have an indirect relationship with the timestamp such that as the value of the timestamp increases, the value(s) for emphasis decreases. For example, recent loop embedding 546 may be assigned an initial level of importance, but as recent loop embedding 546 transitions to older loop embedding 542, its level of importance decays and accordingly, contributes less to aggregated loop embedding 552. In some embodiments, module 510 may apply a first emphasis value for all recent embeddings 546 and 548 and a second emphasis value for all older embeddings 542 and 544.

In various embodiments, loop emphasis 560 and/or mix emphasis 570 may decay after user profile information 520 receives a set number of newer loop embeddings 516 and mix embeddings 518. For example, a recent mix embedding 548 may be reclassified as an older mix embedding 544 after user profile information 520 receives five additional recent mix embeddings 548. As a result, the emphasis of older mix embedding 544 decays such that it is less important relative to the newer recent mix embeddings 548 when computing aggregated mix embedding 554.

In some embodiments, loop emphasis 560 and/or mix emphasis 570 is assigned to loop embedding 516 and mix embedding 518, respectively, based on the classification (e.g., liked) of loop embedding 516 and mix embedding 518. For example, loop emphasis 560 may be applied to liked loop embedding 516A such that it shifts the position of aggregated loop embedding 552 towards liked loop embedding 546A in the embedding space. As a result, machine learning model 140 may select loops similar to liked loop embedding 516A when generating composition decisions 115. As another example, mix emphasis 570 may be applied to a disliked mix embedding 518 such that it shifts the position of aggregated mix embedding 554 away from the disliked mix embedding 518. As a result, machine learning model 140 may selects a mix that is dissimilar to disliked mix embedding 518 when generating composition decisions 115.

### Example Impacts of User Feedback in Multi-Dimensional Space

Turning now to FIG. 6A, a diagram pertaining to an example of a two-dimensional vector space with loop vectors is shown. The two-dimensional space includes a y-axis associated with feature A and an x-axis associated with feature B. For example, the y-axis may be associated with the brightness of a loop, and the x-axis may be associated with the range of a loop. As another example, the illustrated dimensions may be different dimensions of an output vector generated by a contrastive model and therefore may not have any relationship to specific human-understandable features. As discussed above, embeddings may have a high degree of dimensionality, but a two-dimensional example is shown to simplify explanation.

As shown, the example two-dimensional vector space includes liked loop vectors 610A and 610B (denoted by black squares), aggregated loop vector 620 (denoted by a grey square), and current composition target 640 (denoted by a hatch square). A liked loop vector 610, in various embodiments, is a loop that has received positive user feedback 502. For example, a user may submit a “thumbs up” while listening to a loop, and thus, the loop is classified as a liked loop. As shown, the user has liked loop vector 610A with a higher feature A score and a lower feature B score and loop vector 610B with a moderate feature A score and a higher feature B score. Note that similar positions may be tracked for liked/disliked/aggregate mixes, although not shown in FIGS. 6A-6C.

Aggregated loop vector 630, in various embodiments, includes a plurality of components that define its position in the embedding space. In the illustrated embodiment, aggregated loop vector 630 is an average of liked loop vector 610A and 610B, and accordingly, aggregated loop vector 630 is located between liked loop vector 610A and 610B in the two-dimensional space. In some situations, liked loop vector 610B may be a recent loop embedding 546, and as a result, liked loop vector 610B may be weighted differently relative to liked look vector 610A when computing aggregated loop vector 630. For example, liked loop vector 610B may be weighted such that it represents 75% of the weighted average, in which case the aggregated loop vector 630 would be closer to position 610B than to 610A (which is not shown in this example).

In some embodiments, the system may separately track an aggregated liked loop vector and an aggregated disliked loop vector. In other embodiments, liked and disliked loops may be aggregated into a single aggregated vector.

Current composition target 640, in various embodiments, is a vector representation of the current position of a generative composition. For example, it may correspond to an output vector of machine learning module 140 used to select loops with similar vectors. Composition decisions 115 may be determined by the position of aggregated loop vector 630 in the vector space such that the loop(s) selected for current composition target 640 are located within a set distance (e.g., Euclidean) from aggregated loop vector 630. For example, the current composition target 640 may have a value for feature A that is within ten units from the value for feature A of aggregated loop vector 630.

In some embodiments, current composition target 640 is affected over time by the aggregated loop vector 630. Speaking generally, machine learning module 140 may move the current composition target through vector space for various reasons, e.g., to adjust the composition to generate quality music. These adjustments may be affected by the aggregated loop vector input, however, e.g., to attract the current composition target to the aggregated loop vector for liked loops (or to repel the current composition target from an aggregated loop vector for disliked loops, as shown in FIG. 6B). As the user provides feedback 502 over time, aggregated loop vector 630 may move, changing the direction of attraction/repulsion on the current composition target.

Turning now to FIG. 6B, a diagram pertaining to an example of a two-dimensional vector space with a disliked loop vector is shown. As shown, the two-dimensional vector space includes liked loop vector 610A and 610B, disliked loop vector 620A, aggregated loop vector 630, and current composition target 640. Disliked loop vector 620, in various embodiments, is a loop that has received negative user feedback 502. For example, a user may submit a “thumbs down” while listening to a particular loop, and thus, the particular loop is classified as a disliked loop. As shown, the user has disliked the previous composition target 640, as depicted in FIG. 6A, and as a result, the loop from the previous composition target 640 has been classified as disliked loop vector 620A. In this example, a single aggregated loop vector 630 incorporates both liked and disliked loops and attracts the current composition target to its position.

As shown, the position of aggregated loop vector 630 has been adjusted in response to disliked loop vector 620A, relative to its position in FIG. 6A (to move further from the disliked loop vector 620). In this example, the position of the current composition target has also moved (note that this target may move through the space over time even when the aggregated loop vector remains the same). In some embodiments, the impact of a given liked or disliked loop on the aggregated loop vector may be affected based on the distance (e.g., inverse-square law) between aggregated loop vector 630 and disliked loop vector 620A.

Turning now to FIG. 6C, an additional example with another liked loop vector is shown. As shown, the two-dimensional vector space includes liked loop vector s610A-C, disliked loop vector 620A, aggregated loop vector 630, and current composition target 640. In this example, the user has liked the previous composition target 640, as depicted in FIG. 6B, and as a result, the loop from the previous composition target 640 has been classified as liked loop vector 620C. In response to the addition of liked loop vector 620C, the values for the features of aggregated loop vector 630 are updated, shifting the position of vector 630 in the embedding space, accordingly.

### Example Aggregating and Sharing of User Profiles

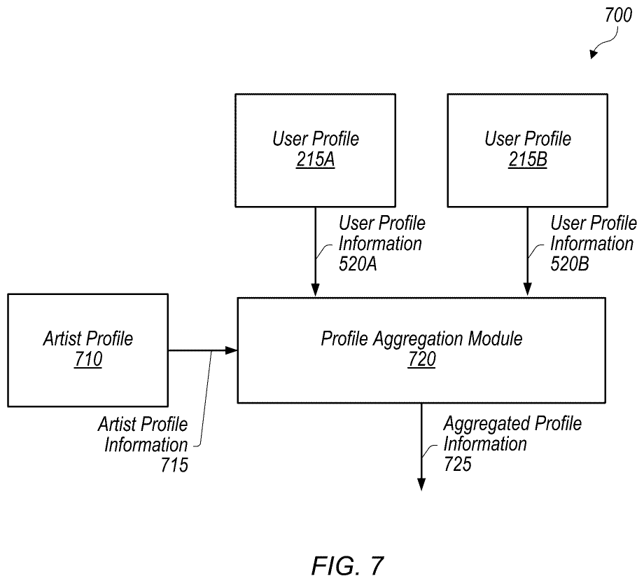

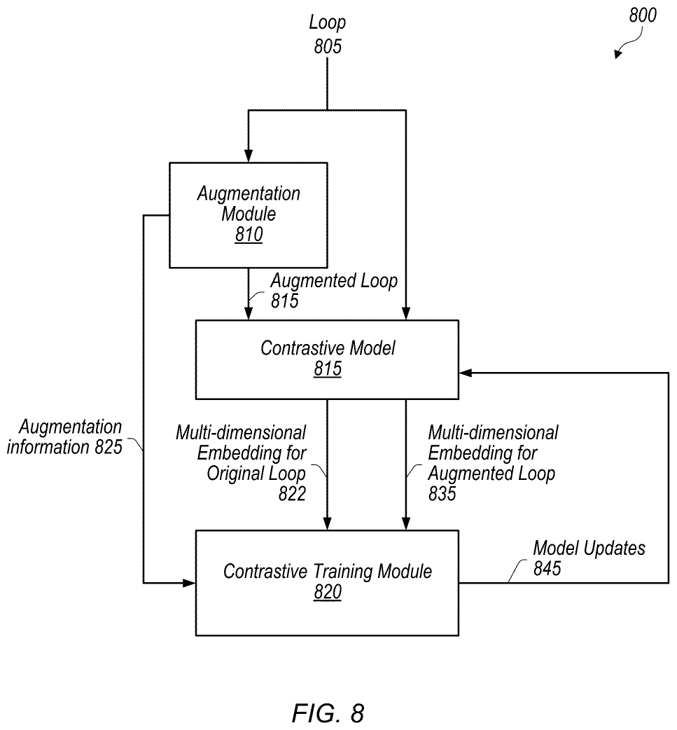

Turning now to FIG. 7, a block diagram of system 700 configured to aggregate a plurality of user profiles and/or artist profiles into aggregated user profile embedding 725 is shown. System 700 includes a set of components that may be implemented via hardware or a combination of hardware and software routines. In the illustrated embodiment, system 700 includes a user profile 215A, user profile 215B, artist profile 710, and profile aggregation module 720. In some embodiments, system 700 is implemented differently than shown. For example, system 700 may include greater or fewer user profiles 215 and greater or fewer artist profiles 710.

Profile aggregation module 720, in various embodiments, is software executable to aggregate user profile information 215 and/or artist profile information 710 into aggregated profile information 725. Aggregated profile information 725 may be a vector representation of a plurality of user profiles 215 and/or artist profiles 710. For example, aggregated profile information 725 may represent the liked and disliked loops and mixes from an N number of user profiles 215 and N number of artist profiles 710. Profile aggregation module 720 provides aggregated profile information 725 to machine learning model 140. Machine learning model 140, in various embodiments, generates composition decisions 115 based on the aggregated profile information 725. For example, machine learning model 140 may receive aggregated profile information 725 from a plurality of users within the same environment, such as the same room, and accordingly, it generates composition decisions 115 that select loops and/or mixes based on the preferences defined by their respective user profile information 520.

In some embodiments, a user may provide user profile information 520 from their user profile 215A directly to a second user profile 215B. For example, a user may share their preferences with a second user, and the second user may listen to loops and/or mixes as defined by those preferences. In some embodiments, a user may receive artist profile information 715 from an artist profile 710 in order to listen to loops and/or mixes as defined by information 715. For example, a user may enjoy the composition decisions 115 generated by a particular artist, and as a result, a user can aggregate their preferences with their favorite artist.

Various aggregation/sharing implementations may share various types of profile information disclosed herein, including loop embeddings, mix embeddings, etc.

### Example Contrastive Model Configured to Generate Portion of Loop/Mix Embedding

Turning now to FIG. 8, a block diagram of system 800 configured to train a contrastive model 816 is shown. Contrastive model 816, in some embodiments, is a machine learning model configured to output a multi-dimensional embedding for an input loop or an input mix. In particular, the model may output, for two different inputs, embeddings whose distance in the multi-dimensional space corresponds to the musical difference between the inputs. Output(s) of model 816 may be included in feedback to machine learning model 140 (e.g., as information about loops included in the current composition), as part of a loop/expression embedding in a user profile, as part of a mix/composition embedding in a user profile, as metadata for a loop in a library, etc. Machine learning model 140 may learn to generate part of its output as a corresponding multi-dimensional vector used to select musical expressions with similar multi-dimensional vectors. Therefore, contrastive model 816 may be used in near-real-time in some scenarios or embodiment or used prior to composition, e.g., to generate metadata for stored loops.

Training system 800 includes a set of components that may be implemented via hardware or a combination of hardware and software routines. In the illustrated embodiment, system 800 includes an augmentation module 810, contrastive model 816, and contrastive training module 820.

Augmentation module 810, in various embodiments, is software executable to modify loop 805, resulting in augmented loop 815, using audio augmentation techniques such as pitch shifting, noise injection, adding reverberation, applying filters, adding distortion, frequency masking, etc. For example, module 810 may adjust the pitch of loop 805, and as a result, module 810 creates augmented loop 815. As shown, module 810 generates augmentation information 825 associated with augmented loop 815 and loop 805. Augmentation information 825, in various embodiments, is metadata that may describe the type of augmentations, amount of augmentation, parameters used by each augmentation, original features values, etc. For example, augmentation information 825 may describe the type of noise and volume added to loop 805 during a noise injection process. As shown, augmentation information 825 is provided to contrastive training module 820, and augmented loop 815 and the original loop 805 are provided to tensor generator/extractor module 510.

Note that the augmented loop 815 and original loop 805 may be provided to contrastive model 816 at different times to generate different outputs. These inputs/outputs are shown in parallel for purposes of explanation but may be separate passes through the model in various embodiments. As shown, model 816 generates a multi-dimensional embedding 822 for the original loop and a multi-dimensional embedding 835 for the augmented loops.

Note that contrastive model 816 may be included in tensor generator/extractor module 510, for example, or may separately generate embeddings for storage and retrieval by tensor generator extractor module 510.

Contrastive training module 820, in various embodiments, is software executable to generate model updates 845 for model 816. For example, module 820 may adjust weights of a neural network implementation of model 816 using contrastive learning-based techniques, such as cosine similarity or Euclidean distance. Model updates 845 may adjust weights used by contrastive model 816 such that distance between loop embedding 822 and augmented loop embedding 835 corresponds to the value of augmentation defined by augmentation information 825. For example, augmentation information 825 may indicate that the pitch of loop 805 was adjusted by ten units, and accordingly, the distance between embeddings 822 and 835 should show that change in the embedding space. In some embodiments, the level of augmentation may be reflected by the cosine similarity or cosine angle between embeddings 822 and 835. For example, if the angle between the two embeddings is smaller, this implies that the level of augmentation is also small.

In some embodiments, the embeddings 822 and 835 are two-dimensional embeddings, although various other dimensionalities are also contemplated.

Training may be considered complete when the differences between the embeddings 822 and 835 correspond to within a threshold degree to known differences between the augmented and original loops. Note that a contrastive model may also be trained to generate multi-dimensional output vectors for multi-loop mixes, in some embodiments.

Turning now to FIG. 9, a diagram illustrating an example data structure for a set of user profile information 520 is shown. In the illustrated embodiment, the data structure is a key value store in which keys 910A-H correspond to values 920A-H. In some embodiments, the key/value pairs 910 and 920 are implemented differently than shown or other data structures may be implemented to store the user profile information. For example, the key/value pairs 910 and 920 may include a fewer or greater number of pairs. As one specific example, while embeddings for an overall mix and for individual loops are discussed, embeddings may also be generated and stored at other granularities, e.g., for groups of loops, categories of loops, etc. In some embodiments, a given key 910 is a unique identification that corresponds with a given value 920 (or set of values 920) for a particular user profile 215.

Liked loop embeddings for user profile A 910A is a key 910 corresponding to a multi-dimensional embedding of one or more liked loops. In some embodiments, each user has a single liked loop embedding vector that aggregates multiple liked loops. In other embodiments, a number of individual loop embedding vectors may be maintained for each user (e.g., up to a limited number of embeddings, within some time threshold, or unlimited). In the latter scenario, each embedding may have a different key or one key may map to the multiple embeddings.

In the illustrated example, embeddings 920A for key 910A include a multi-dimensional embedding of a liked loop (e.g., generated by contrastive model 816) and embeddings/values of features for brightness, hardness, groove, density, range, and complexity. For example, as a user provides positive user feedback 502, the liked loop embedding 516A is stored as a value 920A for their user profile 215. Similarly, key 910B for disliked loop embeddings has similar fields. Each value within the multi-dimensional embedding may be generated by a separate machine learning model (e.g., in real time previously-generated and stored) and concatenated into a single representation.

Liked mix embeddings and disliked mixed embeddings similarly have keys 910C and 910D corresponding to values 920C and 920D with similar fields to the loop embeddings.

Genre listening time for user profile A 910E is a key corresponding to a time value associated with a particular genre, and artist listening time for user profile A 910F is a key corresponding to a time value associated with a particular artist. For example, a user may have listened to techno for 36,000 seconds, and audio generated by a particular artist in the techno genre for 20,000 seconds. Note that a user's “interaction” with a genre or artist may be measured in various ways, including explicit feedback and non-explicit activities such as turning the volume up, listening for a long time period, etc.

Disliked sections for user profile A 910G and liked sections for user profile A 901H are keys corresponding to disliked section identifiers and liked section identifiers, respectively. Note that similar information may be maintained for subsections, in some embodiments. Example sections/sub-sections include into, build-up, drop, decay, bridge, etc.

As machine learning module 140 queries content catalogues, such as a loop library, in an online database, machine learning module 140 may use the illustrated information to filter content according to the information stored about the particular user. For example, machine learning model 140 may use value 920A for a user's liked loop embeddings to filter for other loops with similar embeddings. As another example, machine learning model 140 may use the value 910G for disliked sections for a particular user profile to bias away from sections of music similar to the disliked sections.

In some embodiments, a computer program (e.g., AiMi Studio) facilitates human music composition, e.g., allowing users to record, store, and arrange loops. In some embodiments, disclosed sonic DNA information may be used to provide suggestions to users in this context. For example, the program may implement a model similar to model 140 (including input of profile information for the current user), analyze previous decisions by the composing user (e.g., similar to analysis of audio data 125B), and output predictions regarding subsequent loops that the composer may want to include or mixing techniques that the composer may want to implement. The program may then provide suggestions, e.g., via a user interface, that the composing user may interact with to implement one or more of the suggestions. The suggestions may include specific loops, types of loops or instruments to add, next sections, mixing techniques, etc.

### Example Loop Filtering

In some embodiments, an expert system may be used to train a machine learning model to filter loops for potential selection, e.g., based on the current musical genre. This may advantageously allow the model to filter loops from any of various appropriate sources (including loops not previously encountered) without human intervention. FIG. 10 is a block diagram illustrating an example loop filter model, according to some embodiments. In particular, FIG. 10 shows an example technique for training a loop filter classification model.

In the illustrated example, expert system 110 and module 150 both have access to loops in a loop library 1020. In this example, expert system 110 includes a curated loop filter 1030 that filters loops from module 210 for use by loop selection and mixing module 212. For example, expert users may specify which loops are appropriate for which musical genres, loops may be filtered as usable for a particular artist, etc. Generally, filter 1030 may output a subset of loops from loop library 1020 that are suitable for use which each other. In the illustrated example, module 150 implements a loop filter classification model 1010 that is trained to classify and filter loops based on decisions by curated loop filter 1030.

Loop filter classification model 1010, in the illustrated embodiment, is configured to filter loops (e.g., from loop library 1020 or another library) and output loops that are to be considered for inclusion in a music mix (e.g., based on loop target features 255 discussed above with reference to FIG. 2). In the illustrated example, filter 1030 provides its filtering results (which may include information for both filtered and unfiltered loops). A training module (not shown) then trains model 1010 to make similar classifications. Model 1010 may have any of various appropriate implementations, e.g., neural network, bayes, K-nearest neighbor, decision tree, support vector machine, etc.

In some embodiments, model 1010 attempts to define subsets of loops during training that are usable together, and the training module provides positive rewards if the subset corresponds to filtering decisions by module 1030.

In production scenarios, model 1010 may receive loop characteristics for available loops and control information (e.g., musical genre, artist, environment, etc.) and appropriately filter the loops such that only a subset of available loops is considered by module 150 for inclusion in the music mix. This may advantageously replicate the human-based curation technique of filter 1030.

### Example Methods

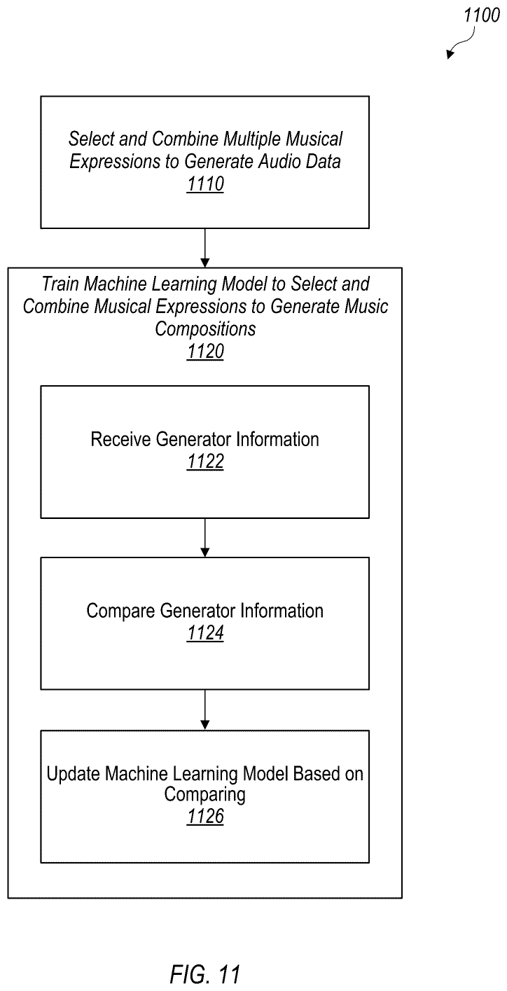

FIG. 11 is a flow diagram illustrating an example method performed by a computer system (e.g., system 100) to train a machine learning model (e.g., machine learning model 140) to select and combine musical expressions (e.g., loops) for generating musical composition data (e.g., audio data 125) similar to a rules-based music generator program (e.g., expert system 110), according to some embodiments. The method shown in FIG. 11 may be used in conjunction with any of the computer circuitry, systems, devices, elements, or components disclosed herein, among others. In various embodiments, some of the method elements shown may be performed concurrently, in a different order than shown, or may be omitted. Additional method elements may also be performed as desired.

At 1110, in the illustrated embodiment, the computer system selects and combines multiple musical expressions, using a rules-based music generator program, to generate first musical composition data (e.g., audio data 125A).

In some embodiments, the computer system generates one or more musical expressions for inclusion in a composition by the machine learning module, based on desired musical expression characteristics output from the machine learning module. The generating process may include applying a diffusion upscale model.

At 1120, in the illustrated embodiment, the computer system trains a machine learning model to select and combine musical expressions to generate music compositions.

In some embodiments, the computer system stores the trained machine learning model on a non-transitory computer-readable medium. The computer system may deploy the trained machine learning model and generate music compositions using the trained machine learning model.

At 1122, in the illustrated embodiment, the training includes receiving generator information that indicates expression selection decisions (e.g., loop target features 255 or loop selection 235A) by the generator program to generate the first audio data, mixing decisions (e.g., mix target features 2655 or mixing control 245A) by the generator program to generate the first audio data, and first audio information output by the generator program based on the generator program's expression selection decisions and the mixing decisions. In some embodiments, the selection decisions consist of information that specifies desired target characteristics of musical expressions to be selected. In other embodiments, the selection information may include identification or characteristics of actually-selected musical expressions.

In some embodiments, the first audio information and the second audio information each include audio data and spectrogram data (e.g., spectrogram 220) generated based on the audio data. The training may be further based on user feedback input (e.g., user feedback 225A and 225B) to both the generator program and the machine learning model. The training may include generating simulated user feedback (e.g., music quality feedback 325) using a user feedback simulation machine learning model (e.g., included in user feedback generation module 310) and using the simulated user feedback as a user feedback input for the training. In some embodiments, the training includes providing a training vector to the machine learning model that includes raw audio data, processed audio data that includes spectrogram data, features of recently composed audio data extracted by a machine learning model, user feedback, and information indicating current conditions.

At 1124, in the illustrated embodiment, the training includes comparing the generator information to expression selection decisions by the machine learning model, mixing decisions by the machine learning model, and second audio information generated by the machine learning model based on the machine learning model's expression selection decisions and mixing decisions.

In some embodiments, the training includes providing a training vector to the machine learning model that includes a multi-dimensional output of a contrastive training model (e.g., model 815). The contrastive training model may be trained to provide outputs for different musical expressions that correspond to musical differences between the different musical expressions. The multi-dimensional output of the contrastive training model may be provided for a musical expression for which a user previously provided feedback, a musical expression selected one or more musical expressions selected by the machine learning model, and/or mixed audio generated by the machine learning model.

At 1126, in the illustrated embodiment, the training includes updating (e.g., model updates 135) the machine learning model based on the comparing.

In some embodiments, the method includes training a filter classification model (e.g., model 1010) to determine a proper subset of musical expressions from a set of available musical expressions, wherein the training is based on pre-determined sets of musical expressions suitable for mixing together.

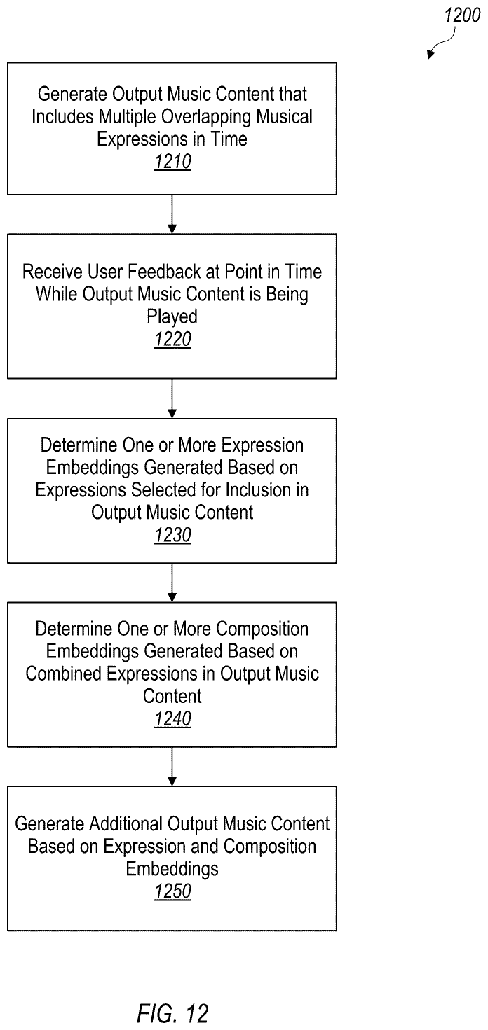

FIG. 12 is a flow diagram illustrating an example method performed by a computer system to train a machine learning model (e.g., machine learning model 140) to select and combine musical expressions (e.g., composition decisions 115) for generating musical composition data (e.g., audio data 125) based on user feedback, according to some embodiments. The method shown in FIG. 12 may be used in conjunction with any of the computer circuitry, systems, devices, elements, or components disclosed herein, among others. In various embodiments, some of the method elements shown may be performed concurrently, in a different order than shown, or may be omitted. Additional method elements may also be performed as desired.

At 1210, in the illustrated embodiment, the computer system generates output music content (e.g., composition decisions 115) that includes multiple overlapping musical expressions in time. In some embodiments, the computer system generates output music content by selecting expressions and combining expressions.

At 1220, in the illustrated embodiment, the computer system receives user feedback (e.g., user feedback 502) at a point in time while the output music content is being played.

In some embodiments, the computer system combines embeddings determined based on feedback from multiple different users to generate at least one of the expression embeddings (e.g., expression embedding 512) and the composition embeddings (e.g., composition embedding 514).

At 1230, in the illustrated embodiment, based on the user feedback and based on characteristics of the output music content (e.g., current composition parameters/details 504) associated with the point in time, the computer system determines one or more expression embeddings generated based on expressions selected for inclusion in the output music content.

In some embodiments, at least one of the one or more expression embeddings is a vector that represents a first set of features extracted from a musical expression included in the output music content (e.g., as shown in FIG. 9).

At 1240, in the illustrated embodiment, based on the user feedback and based on characteristics of the output music content associated with the point in time, the computer system determines one or more composition embeddings generated based on combined expressions in the output music content.

In some embodiments, at least one of the one or more composition embeddings is a vector that represents a second set of features extracted from a combined set of expressions in the output music content. The first set of features may include brightness, range, and/or complexity. At least one of the one or more expression embeddings, at least one of the one or more composition embeddings, or both is a multi-dimensional embedding may be generated by a contrastive machine learning model (e.g., contrastive model 815). In some embodiments, the contrastive model is trained (e.g., by model updates 845) to provide outputs for different input musical content. The distance between the outputs in a multi-dimensional space may correspond to musical differences between the different input musical content. The computer system may train the contrastive model by adjusting first music content (e.g., loop 805) to generate second music content (e.g., augmented loop 815), provide the first and second music content to the contrastive model, and compare differences in outputs generated by the contrastive model to known differences corresponding to the adjusting.

At 1250, the computer system generates additional output music content based on the expression and composition embeddings.

In some embodiments, the computer system uses different emphasis (e.g., loop emphasis 560 and mix emphasis 570) for different embeddings. A first emphasis for a first embedding (e.g., recent loop embedding 546) may be greater than a second emphasis for a second embedding (e.g., older loop embedding 542) based on user feedback corresponding to the first embedding being received later in time than user feedback corresponding to the second embedding. The generating may be based on an aggregation of multiple embeddings of the expression embeddings.

In some embodiments, the computer further determines one or more third embeddings based on genre of music content interacted with by the user, and the generating is further based on the one or more third embeddings. The computer may further determine one or more fourth embeddings based on one or more artists of music content interacted with by the user, and the generating is further based on the one or more fourth embeddings. The computer system may further determine one or more fifth embeddings based on musical sections being played in the output music content, and the generating is further based on the one or more fifth embeddings. The generating may further be based on embedding information shared by a first user (e.g., user profile information 520A) with a second user (e.g., user profile information 520B). The computer system may suggest for a manual music composition tool, one or more musical expressions based on the expression and composition embeddings.

1. A method, comprising:
generating, by a computing system executing a music composition program, output music content that includes multiple overlapping musical expressions in time, wherein the generating includes selecting expressions and combining expressions;
receiving, by the computing system, user feedback at a point in time while the output music content is being played;
determining, by the computing system based on the user feedback and based on characteristics of the output music content associated with the point in time:
one or more expression embeddings generated based on expressions selected for inclusion in the output music content; and
one or more composition embeddings generated based on combined expressions in the output music content; and
generating, by the computing system, additional output music content based on the expression and composition embeddings.

2. The method of claim 1, wherein:
at least one of the one or more expression embeddings is a vector that represents a first set of features extracted from a musical expression included in the output music content; and
at least one of the one or more composition embeddings is a vector that represents a second set of features extracted from a combined set of expressions in the output music content.

3. The method of claim 2, wherein:
the first set of features includes two or more of the following features: brightness, range, and complexity.

4. The method of claim 1, wherein at least one of the one or more expression embeddings, at least one of the one or more composition embeddings, or both is:
a multi-dimensional embedding generated by a contrastive machine learning model, wherein the contrastive model is trained to provide outputs for different input musical content, wherein a distance between the outputs in a multi-dimensional space corresponds to musical differences between the different input musical content.

5. The method of claim 4, further comprising:
training, by the computing system, the contrastive model by:
adjusting first music content to generate second music content;
providing the first and second music content to the contrastive model; and
comparing differences in outputs generated by the contrastive model to known differences corresponding to the adjusting.

6. The method of claim 1, wherein the generating uses different emphasis for different embeddings.

7. The method of claim 6, wherein a first emphasis for a first embedding is greater than a second emphasis for a second embedding based on user feedback corresponding to the first embedding being received later in time than user feedback corresponding to the second embedding.

8. The method of claim 1, wherein the generating is based on an aggregation of multiple embeddings of the expression embeddings.

9. The method of claim 1, wherein:
the determining further includes determining one or more third embeddings based on genre of music content interacted with by the user; and
the generating is further based on the one or more third embeddings.

10. The method of claim 1, wherein:
the determining further includes determining one or more fourth embeddings based on one or more artists of music content interacted with by the user; and
the generating is further based on the one or more fourth embeddings.

11. The method of claim 1, wherein:
the determining further includes determining one or more fifth embeddings based on musical sections being played in the output music content; and
the generating is further based on the one or more fifth embeddings.

12. The method of claim 1, further comprising:
combining, by the computing system, embeddings determined based on feedback from multiple different users to generate at least one of the expression embeddings and the composition embeddings.

13. The method of claim 1, wherein the generating is further based on embedding information shared by a first user with a second user.

14. The method of claim 1, further comprising:
suggesting, by the computing system for a manual music composition tool, one or more musical expressions based on the expression and composition embeddings.

15. A non-transitory computer-readable medium having instructions stored thereon that are executable by a computing device to perform operations comprising:
generating, by executing a music composition program, output music content that includes multiple overlapping musical expressions in time, wherein the generating includes selecting expressions and combining expressions;
receiving user feedback at a point in time while the output music content is being played;
determining, based on the user feedback and based on characteristics of the output music content associated with the point in time:
one or more expression embeddings generated based on expressions selected for inclusion in the output music content; and
one or more composition embeddings generated based on combined expressions in the output music content; and
generating additional output music content based on the expression and composition embeddings.

16. The non-transitory computer-readable medium of claim 15, wherein at least one of the one or more expression embeddings, at least one of the one or more composition embeddings, or both is:
a multi-dimensional embedding generated by a contrastive machine learning model, wherein the contrastive model is trained to provide outputs for different input musical content, wherein a distance between the outputs in a multi-dimensional space corresponds to musical differences between the different input musical content.

17. The non-transitory computer-readable medium of claim 16, wherein the operations further comprise:
training the contrastive model by:
adjusting first music content to generate second music content;
providing the first and second music content to the contrastive model; and
comparing differences in outputs generated by the contrastive model to known differences corresponding to the adjusting.

18. The non-transitory computer-readable medium of claim 15, wherein:
the generating uses different emphasis for different embeddings; and
a first emphasis for a first embedding is greater than a second emphasis for a second embedding based on user feedback corresponding to the first embedding being received later in time than user feedback corresponding to the second embedding.

19. The non-transitory computer-readable medium of claim 15, wherein the determining further includes determining one or more embeddings based on:
an artist being played;
a genre being played; and
a musical section being played.

20. A system, comprising:
one or more processors; and
one or more non-transitory computer-readable media having instructions stored thereon that are executable by the one or more processors to:
generate, based on execution of a music composition program, output music content that includes multiple overlapping musical expressions in time, wherein the generating includes selecting expressions and combining expressions;
receive user feedback at a point in time while the output music content is being played;
determine, based on the user feedback and based on characteristics of the output music content associated with the point in time:
one or more expression embeddings generated based on expressions selected for inclusion in the output music content; and
one or more composition embeddings generated based on combined expressions in the output music content; and
generate additional output music content based on the expression and composition embeddings.
